(19) United States
(12) Patent Application Publication
(10) Pub. No.: US 2015/0354416 A1
(43) Pub. Date: Dec. 10, 2015

(54) CAMSHAFT ADJUSTER

(71) Applicant: SCHAEFFLER TECHNOLOGIES AG & CO. KG, Herzogenaurach (DE)

(72) Inventor: Holger Brenner, Obermichelbach (DE)

(73) Assignee: SCHAEFFLER TECHNOLOGIES AG & CO. KG, Herzogenaurach (DE)

(21) Appl. No.: 14/758,723

(22) PCT Filed: Nov. 8, 2013
(86) PCT No.: PCT/DE2013/200286

§ 371 Date: Jun. 30, 2015

(30) Foreign Application Priority Data
Jan. 18, 2013 (DE) 10 2013 200 766.3
Feb. 27, 2013 (DE) 10 2013 203 247.1

(51) Int. Cl. F01L 1/344; F16H 53/04

(52) U.S. Cl. CPC F01L 1/3442; F16H 53/04; F01L 2001/3445

(57) ABSTRACT

A drive element (1) of a camshaft adjuster, wherein the drive element (1) is designed such that it can be driven by a timing gear and the drive element (1) has at least one through bore (2), wherein the through bore (2) has a thread (3), wherein the axial length (x) of the thread (3) is smaller than the axial length (y) of the through bore (2) is provided. Also proposed is a camshaft adjuster having a drive element (1).

The present invention relates to a camshaft adjuster.

### BACKGROUND

Camshaft adjusters are used in internal combustion engines to vary the control times of the combustion chamber valves to be able to vary the phase relation between a crankshaft and a camshaft in a defined angle range between a maximum advance position and a maximum retard position. Adjusting the control times to the instantaneous load and rotational speed reduces consumption and emissions. For this purpose, camshaft adjusters are integrated into a drive train, via which a torque is transferred from the crankshaft to the camshaft. This drive train may be designed, for example, as a belt, chain or gear drive.

In a hydraulic camshaft adjuster, the output element and the drive element form one or multiple pair(s) of counteracting pressure chambers to which a hydraulic medium is applied. The drive element and the output element are coaxially situated. A relative movement between the drive element and the output element is created by filling and emptying individual pressure chambers. The rotatively acting spring between the drive element and the output element pushes the drive element toward the output element in an advantageous direction. This advantageous direction may be in the same direction or in the opposite direction of the direction of rotation.

One design of the hydraulic camshaft adjuster is the vane adjuster. The vane adjuster includes a stator, a rotor and a drive wheel which has an external toothing. The rotor as the output element is usually designed to be rotatably fixedly connectable to the camshaft. The drive element includes the stator and the drive wheel. The stator and the drive wheel are rotatably fixedly connected to each other or, alternatively, they are designed to form a single piece with each other. The rotor is situated coaxially with respect to the stator and inside the stator. Together with their radially extending vanes, the rotor and the stator form oppositely acting oil chambers to which oil pressure may be applied and which facilitate a relative rotation between the stator and the rotor. The vanes are either designed to form a single piece with the rotor or the stator or are situated as “plugged-in vanes” in grooves of the rotor or stator provided for this purpose. The vane adjusters furthermore have various sealing covers. The stator and the sealing covers are secured to each other with the aid of multiple screw connections.

Another design of the hydraulic camshaft adjuster is the axial piston adjuster. In this case, a shifting element, which creates a relative rotation between a drive element and an output element via inclined toothings, is axially shifted with the aid of oil pressure.

A further design of a camshaft adjuster is the electromechanical camshaft adjuster, which has a three-shaft gear set (for example, a planetary gear set). One of the shafts forms the drive element and a second shaft forms the output element. Rotation energy may be supplied to the system or removed from the system via the third shaft with the aid of an actuating device, for example an electric motor or a brake. A spring may be additionally situated, which supports or feeds back the relative rotation between the drive element and the output element.

U.S. 2002/0050258 A1 shows a camshaft adjuster, the chain wheel being screwed to the housing. A vane rotor, which is rotatably fixedly screwed to the camshaft, is accommodated in the housing.

### SUMMARY OF THE INVENTION

An object of the present invention is to provide a drive element of a camshaft adjuster as well as a camshaft adjuster which includes a drive element, it being possible to fasten peripheral components to the drive element particularly cost-effectively and reliably.

The present invention provides a camshaft adjuster, the drive element being designed to be drivable by a timing drive, the drive element having at least one through-bore, the through-bore having a thread, the object being achieved by the fact that the axial length of the thread is smaller than the axial length of the through-bore.

The drive element may have a receptacle for an output element which is connectable to a camshaft. The drive element may furthermore be designed as a drive wheel, for example as a chain wheel, a belt pulley or a gear wheel. The drive element may be formed from multiple components, for example a first component which includes a receptacle for an output element and a second component which is rotatably fixedly connected to the first component and is designed as a drive wheel.

It is achieved hereby that time is saved, in particular when manufacturing the thread, and the thread-cutting tool is furthermore protected so that a higher quantity may be achieved.

In one embodiment of the present invention, the thread has a distance from a first side of the through-bore which is less than the distance from the second side of the through-bore opposite the first side.

The thread may begin at the first side and is not provided continuously to the second side. This advantageously reduces the manufacturing complexity.

In one advantageous embodiment, the thread extends into the through-bore, starting directly from the first side. Alternatively, the thread may also have a distance from the first side, this distance being smaller than the distance of the thread from the second side.

In one particularly preferred embodiment, a bush which forms the thread is inserted into the through-bore. This bush may be advantageously made of a material which is different from the drive element and which is better suited for manufacturing a thread and may be thermally treated separately from the drive element. For example, the drive element may be made of an aluminum alloy or a plastic or a plastic composite. The bush may be made, for example, of stronger material, such as a nonferrous metal alloy or an iron alloy.

It is furthermore advantageous that this bush may be positioned in the through-bore, in contrast to a thread which is cut into the through-bore.

In one embodiment of the present invention, the bush has a distance from a first side of the through-bore which is less than the distance from the second side of the through-bore opposite the first side.

In one preferred embodiment, the bush has a shoulder, and the through-bore is designed as a stepped bore, the shoulder of the bush contacting the step of the stepped bore. The shoulder of the bush is advantageously supported on the step of the stepped bore within the through-bore of the drive element when the screw is screwed into the thread and is tightened or braced.

In another preferred embodiment, the bush has a shoulder, the shoulder of the bush contacting the first side of the through-bore. The shoulder of the bush is advantageously supported on the first side of the through-bore outside the through-bore on the drive element when the screw is screwed into the thread and is tightened or braced.

A camshaft adjuster which includes a drive element is furthermore proposed, the camshaft adjuster also including an output element, the drive element and the output element being situated coaxially to the rotation axis of the camshaft adjuster, the drive element and the output element including multiple, radially oriented vanes, the drive element and the output element forming oppositely acting working chambers, each working chamber being defined by a vane pair which includes one vane of the drive element with one vane of the output element, and it being possible to pressurize the working chambers using a hydraulic medium for the purpose of achieving a relative rotation between the drive element and the output element.

In one embodiment, a cover element is situated adjacent to the drive element, the cover element having a through-opening which is aligned with the through-bore of the drive element, a screw penetrating the through-opening of the cover element and engaging with the thread.

In one advantageous embodiment of the camshaft adjuster, which includes the drive element, the through-bore having the thread is formed by a vane of the drive element. The flux of force may thus be advantageously defined in a targeted manner during fastening of the cover element with the aid of a screw.

Due to the arrangement of the thread in the through-bore according to the present invention, an optimization of the flux of force when bracing components to be fastened to each other and a targeted influence of the stress concentrations as well as an economical manufacture are achieved.

### BRIEF DESCRIPTION OF THE DRAWINGS

Exemplary embodiments of the present invention are illustrated in the figures.

FIG. 1a shows a first embodiment of the drive element, including a short thread which does not extend along the entire through-bore;

FIG. 1b shows a second embodiment of the drive element, including a short thread which does not extend along the entire through-bore; and

FIG. 2 shows a drive element, including a bush which has a shoulder and is situated in a stepped bore.

### DETAILED DESCRIPTION

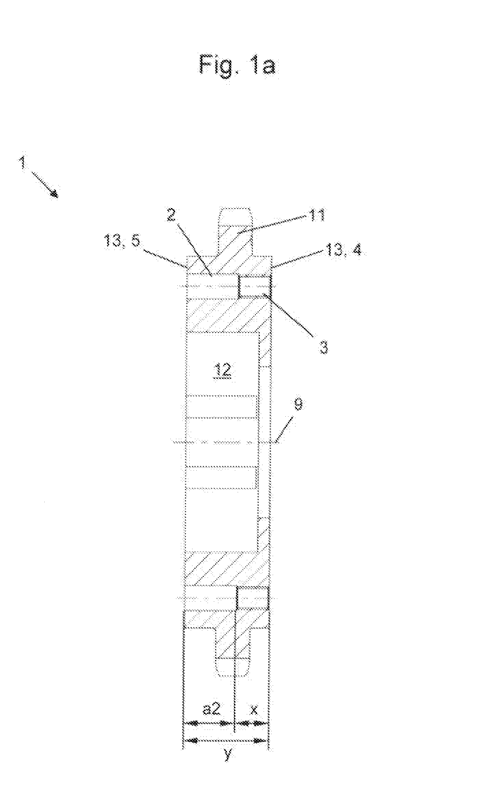

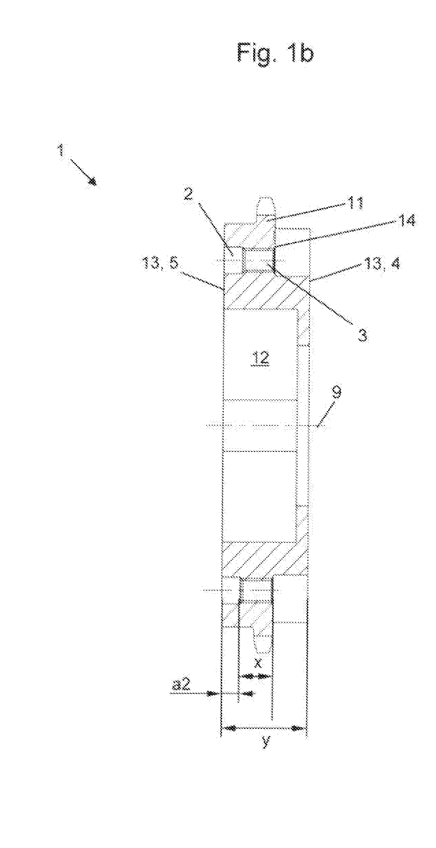

FIG. 1a shows a first embodiment of drive element 1, including a short thread 3, which does not extend along the entire through-bore 2.

Drive element 1 is designed as a stator including vanes, which is known from the prior art. Drive element 1 includes an integratively formed toothing 11, which may be brought into engagement with a timing drive. A receptacle 12 is also provided, in which an output element may be situated coaxially to drive element 1 and thus also to rotation axis 9 of a camshaft adjuster.

Drive element 1 has two planar front sides 13, a first side 4 and a second side 5. A cover element is fastened on second side 5 during the further course of assembly. Thread 3 of through-bore 2 begins directly at first side 4 and does not extend completely along through-bore 2 to second side 5. A screw, which is supposed to fasten the cover element, may thus have a long screw shaft, which has an advantageous effect on the pretensioning force. The portion of through-bore 2 which is not occupied by thread 3 may be designed to have a larger diameter than thread 3, whereby additional weight may be saved, and the thread may be easier to manufacture. Screws of identical design may preferably be used for several different drive elements 1 with the aid of the positioning of thread 3 or the purposefully designed thread length.

Distance a2 is defined by front surface 13 of second side 5 and the end of thread 3, which begins directly from first side 4. Axial length x of thread 3 is smaller than axial length y of through-bore 2 and smaller than distance a2. Distance a2 may be available to a screw shaft or used as an expansion section in the screw assembly for achieving the desired pretension.

FIG. 1b shows a second embodiment of drive element 1, including a short thread 3, which does not extend along entire through-bore 2. In contrast to FIG. 1a, first side 4 in this case is not the axially terminating side of drive element 1 but rather a planar surface 14 which is situated offset and in parallel with respect to first side 4 designed as front surface 13 in FIG. 1a. Surface 14 according to FIG. 1b does not have a circumferential design but exists only in the area of through-bore 2.

Distance a2 is defined by front surface 13 of second side 5 and the end of thread 3, which begins directly from surface 14. Axial length x of thread 3 is smaller than axial length y of through-bore 2 and greater than distance a2.

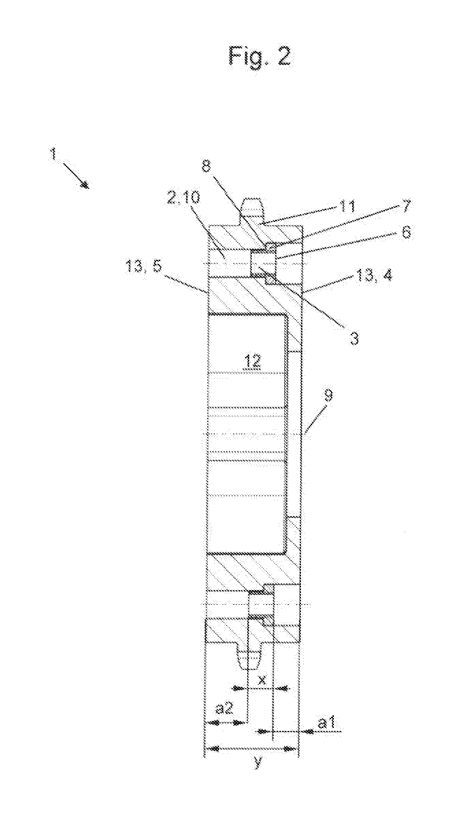

FIG. 2 shows a drive element 1, including a bush 6, which has a shoulder 7 and is situated in a stepped bore 10. Bush 6 rests with its shoulder 7 against a step 8 of through-bore 2, which is designed as stepped bore 10. Depending on the placement of step 8, the clamping length of the later screw assembly may be influenced. Screws of identical design may preferably be used for several different drive elements with the aid of the positioning of the bush.

Distance a2 is defined by front surface 13 of second side 5 and the end of thread 3, which begins directly from first side 4 and is formed by bush 6. Thread 3 extends along the entire axial length of bush 6. Axial length x of thread 3 is smaller than axial length y of through-bore 2. Distance a1, which is provided between thread 3 and first side 4 designed as front surface 13, is smaller than distance a2. Distance a2 may be available to a screw shaft or used as an expansion section in the screw assembly for achieving the desired pretension.

### LIST OF REFERENCE NUMERALS

1) drive element
2) through-bore
3) thread
4) first side
5) second side
6) bush
7) shoulder
8) step
9) rotation axis
10) stepped bore
11) toothing
12) receptacle
13) front surfaces
14) surface
a1) distance
a2) distance
b1) distance
b2) distance
x) axial length (thread)
y) axial length (through-bore)

What is claimed is:

1-10. (canceled)

11. A drive element of a camshaft adjuster, the drive element being designed to be drivable by a timing drive and comprising:
at least one through-bore, the through-bore having a thread, an axial length of the thread being smaller than the axial length of the through-bore.

12. The drive element as recited in claim 11 wherein the thread has a distance from a first side of the through-bore less than a second distance from a second side of the through-bore opposite the first side.

13. The drive element as recited in claim 12 wherein the thread extends into the through-bore, starting directly from the first side.

14. The drive element as recited in claim 11 further comprising a bush forming the thread, the bush being inserted into the through-bore.

15. The drive element as recited in claim 14 wherein the bush has a distance from a first side of the through-bore less than a second distance from a second side of the through-bore opposite the first side.

16. The drive element as recited in claim 15 wherein the bush has a shoulder, and the through-bore is designed as a stepped bore, the shoulder of the bush contacting a step of the stepped bore.

17. The drive element as recited in claim 15 wherein the bush has a shoulder, the shoulder of the bush contacting the first side of the through-bore.

18. A camshaft adjuster comprising the drive element as recited in claim 11 and including an output element, the drive element and the output element being situated coaxially to the rotation axis of the camshaft adjuster, the drive element and the output element including multiple, radially oriented vanes, the drive element and the output element forming oppositely acting working chambers, each working chamber being defined by a vane pair which includes one vane of the drive element with one vane of the output element, and it being possible to pressurize the working chambers using a hydraulic medium for the purpose of achieving a relative rotation between the drive element and the output element.

19. The camshaft adjuster as recited in claim 18 further comprising a cover element is situated adjacent to the drive element, the cover element having a through-opening aligned with the through-bore of the drive element, a screw penetrating the through-opening of the cover element and engaging with the thread.

20. The camshaft adjuster as recited in claim 18 wherein the through-bore is formed by a vane of the drive element.
